(19) United States
(12) Patent Application Publication
(10) Pub. No.: US 2009/0179394 A1
(43) Pub. Date: Jul. 16, 2009

(54) Interactive stroller for educating a child

(76) Inventors: Kathryn Michele Huber, Miami, FL (US); Liza F. Fairciough, Miami, FL (US)

Correspondence Address: RUBEN ALCOBA, ESQ., 3399 NW 72 AVENUE, SUITE211, MIAMI, FL, 33122, US

(21) Appl. No.: 12/008,346

(22) Filed: Jan. 10, 2008

(51) Int. Cl. B62B 9/00; A47D 15/00

(52) U.S. Cl. 280/47.38; 224/409

(57) ABSTRACT

An interactive stroller for educating a child comprises of a stroller, a tray attached to the stroller, a player housed within the tray, and a controller attached within the handle of the stroller. The player might be interactive or a passive player, e.g., a CD player. The controller might be attached by either radio frequency or a wired connection to the player.

### BACKGROUND

The inventors of the present invention realized that there is a need for entertaining a child while the child sits within a stroller. They further realized that the child would be better off receiving active rather than passive entertainment.

The current method of entertaining a child within a stroller is providing the child with a toy. The child usually losses interest within five minutes of playing with the toy and the toy ends up on the ground. When the toy ends up on the ground, then it is time for the adult monitoring the child to provide the child with another form of entertainment or withstand the child's outburst.

Parents are the best witnesses as to how taxing it is to take a young child shopping or any other place while the child sits within a stroller.

The inventors realized that they had to invent a stroller that would stimulate a young child's mind when the child sits within the stroller. That the stimulation provided had to be continuous so that the child would not lose interest in the stimulation. They further realized that they had to provide a stream of information, whether passive or active, the key was that the stimulation had to provide constant visual and audio input to the child so that the child would not lose interest. And they lastly realized that active rather than passive entertainment would be the best type of stimulation that a child could receive.

An object of the present invention is to provide a child with stimulation while the child sits within a stroller.

Another object of the present invention is to provide a parent with a means of entertaining a child while a child sits in a stroller.

A further object of the present invention is to provide a child with entertainment while the child sits in the stroller.

Another object of the present invention is to provide the user of the stroller a means for controlling the entertainment a child views while the child sits in the stroller.

### SUMMARY

The present invention, an interactive stroller for educating a child, solves the need of entertaining a child while a child sits within a stroller. The interactive stroller for educating a child comprises of a stroller, a tray attached to the stroller, a player housed within the tray, and a controller attached within the handle of the stroller. The player might be interactive or a passive player, e.g., a CD player. The controller might be attached by either radio frequency or a wired connection to the player.

If the player is interactive, a program would be written to be played within the player and the player would have a touch screen so that the child could interact with the player.

The controller of the stroller allows the adult caring for the child to remotely select what the child interacts with. It is foreseen that a young child will actually believe that the images within the player are actually communicating with the child.

It is very important to provide active or passive entertainment to the player so that the child's interests are addressed in a manner that the child believes the audio and video being generated from the player are communicating with the child.

### DRAWINGS

These and other features, aspects, and advantages of the present invention will become better understood with regard to the following description, appended claims, and drawings where:

FIG. 1 shows a perspective view of an interactive stroller for educating a child;

FIG. 2 shows a perspective view of a tray and a player combination on the arms of the stroller of the interactive stroller;

FIG. 3a shows a side view of the player housed within the tray, the view shows how the player can be moved from an open position to a closed position;

FIG. 3b shows a side view of the player and the tray, wherein the player is in the open position;

FIG. 4 shows a side view of a locking mechanism that locks the player within the tray of the interactive stroller;

FIG. 5a shows a side view of the male holding devices of the player and the inlets of the tray, the male holding device being inserted within the inlets;

FIG. 5b shows a side view of the male holding devices of the player and the inlets of the tray, the male holding device being retracted from the inlets;

FIG. 6 shows a perspective of the player, the view shows a charging device to connect to the player;

FIG. 7 shows a side view of the tip of the male holding means of the player;

FIG. 8 shows a perspective of a controller on the handle of the interactive stroller; and

FIG. 9 shows a rear view of the interactive stroller showing the pouch of the stroller.

### DESCRIPTION

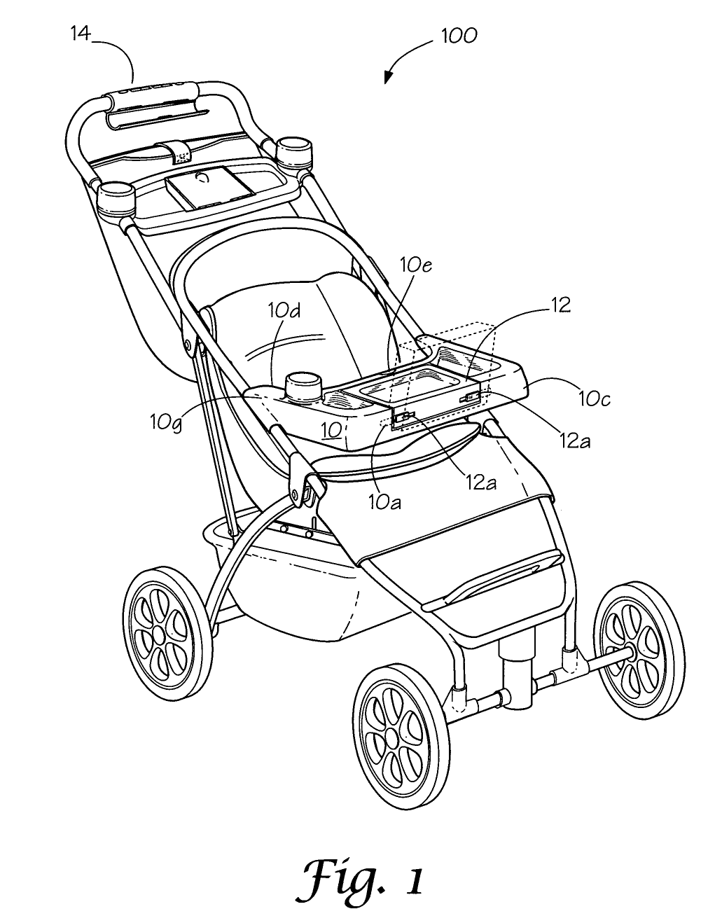

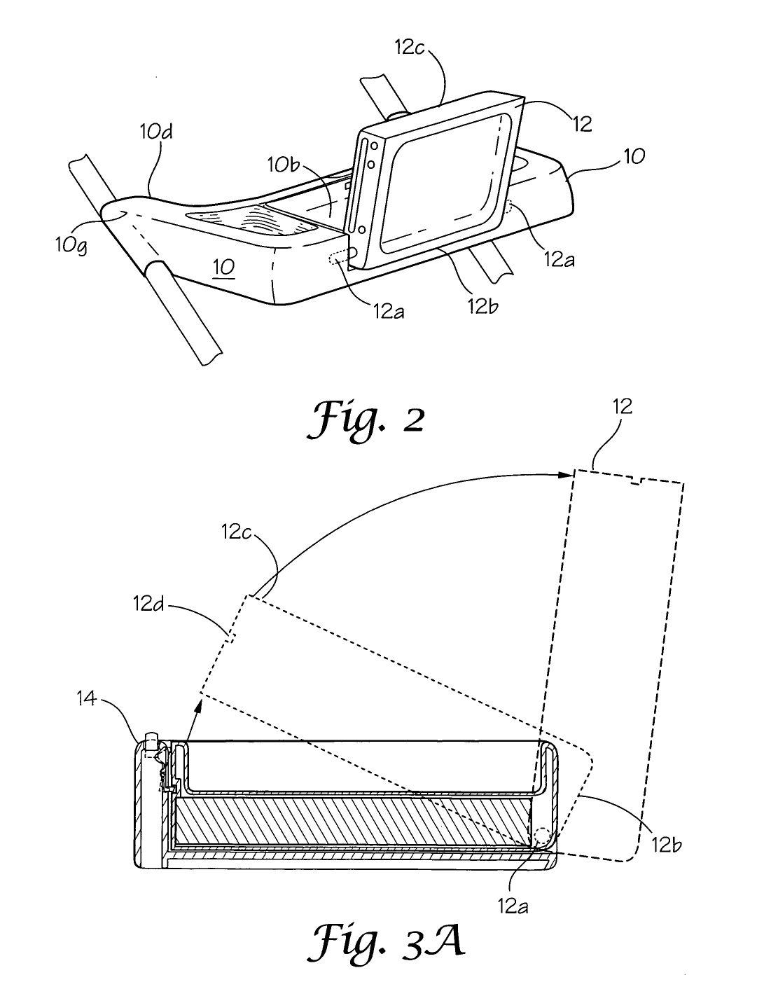

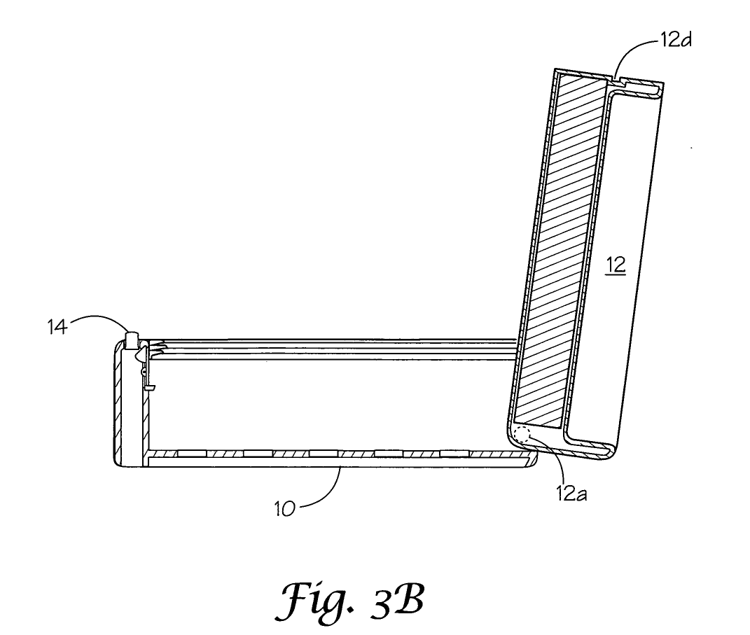

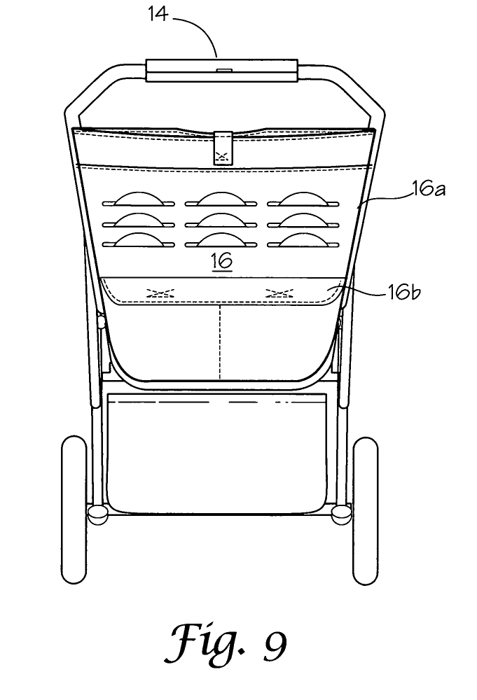

As seen in FIG. 9 an interactive stroller for educating a child comprises a stroller 100, the stroller having at least three wheels, a handle, a seat, and a pair of arms. As seen in FIGS. 1-5b the interactive stroller 100 also comprises of a tray 10, the tray 10 attaches to the stroller 100. As seen in FIGS. 1-7 the interactive stroller 100 further comprises of a player 12, the player 12 attaches to the tray 10. As seen in FIG. 1 the interactive stroller might also further comprise of a controller 14, the controller 14 attaches to the stroller's handle 100, the controller 14 connects to the player 12.

As seen in FIGS. 1-5b the tray 10 has a front 10c and a back 10d, the tray 10 defines a centrally located recess 10b, the tray 10 further defines at least two directly opposing inlets 10a positioned adjacent to the front of the tray 10, the tray 10 also defines a centrally located channel 10e adjacent to the rear of the tray 10, and the tray 10 lastly defines two holding means 10g that attach to the arms 100 of the stroller 100.

As seen in FIGS. 1-7 the player 12 has a front 12c and a back 12b end, the back 12b end of the player 12 having two male holding devices 12a, the male holding devices 12a being directly opposed to each other, each male holding device 12a being able to be in either an extended or a retracted position, the male holding devices 12a being inserted within the inlets 10a of the tray 10, the player 12 further defines an opening 12c centrally located in the front of the player 12.

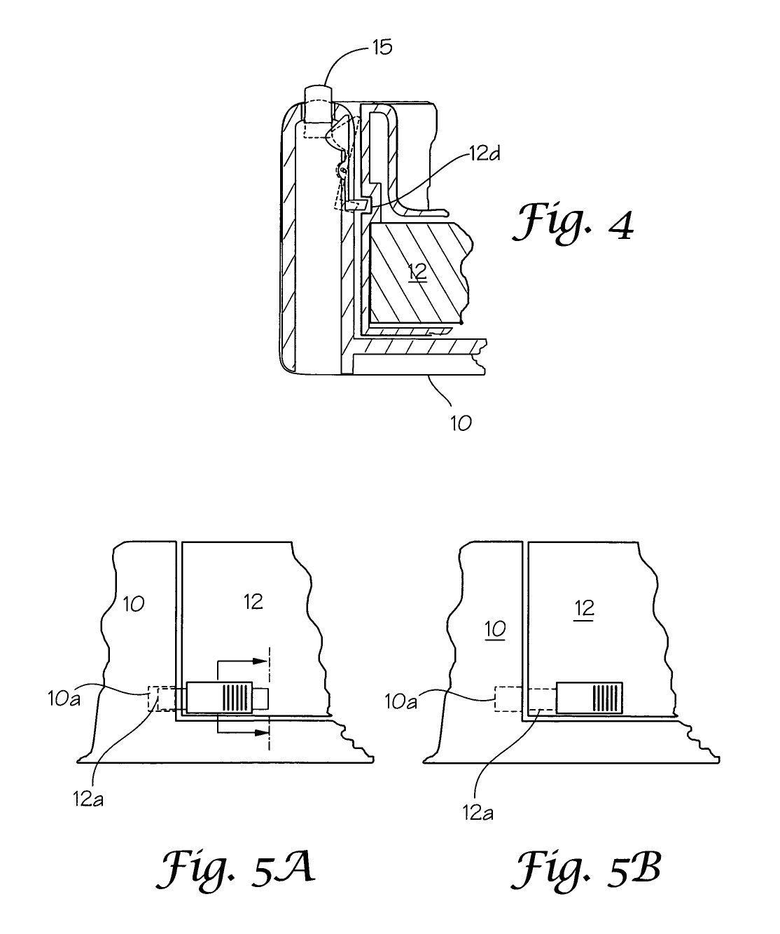

As seen in FIG. 4 the interactive stroller might further comprise of a locking means 15 for locking the player 12 within the recess 10b of the tray 10, the locking means 15 is housed within the channel 10e of the tray 10.

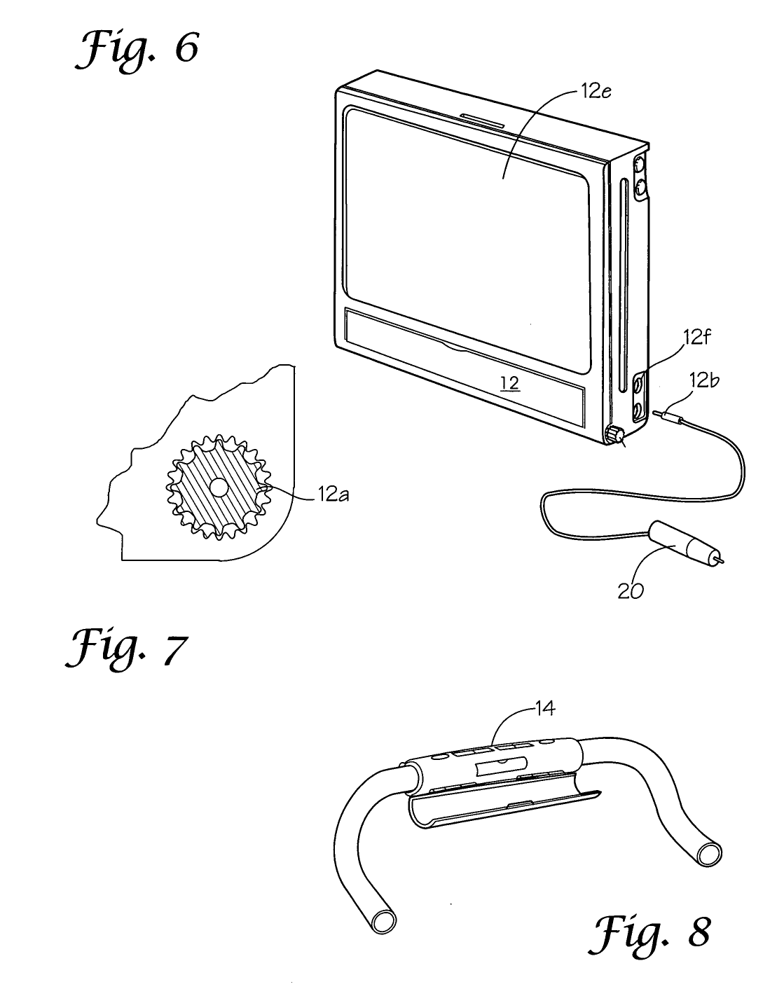

As seen in FIG. 6 the interactive stroller might further comprise a charging device 20b, the charging device 20b attaches to the player 12.

As seen in FIG. 9 the interactive stroller might further comprise a pouch 16, the pouch 16 attaches to the stroller 100, the pouch 16 defines a means for storing CD's 16a or other items 16b.

The player 12 of the present invention might be interactive and might have a touch screen 12e. The controller 14 might control the player 12 via radio frequency waves.

An advantage of the present invention is that it provides a child with stimulation while the child sits within a stroller.

Another advantage of the present invention is that it provides a parent with a means of entertaining a child while a child sits in the stroller.

A further advantage of the present invention is that it provides a child with entertainment while the child sits in the stroller.

Another advantage of the present invention is that it provides the user of the stroller a means for controlling the entertainment a child is viewing while the child sits in the stroller.

Although the present invention has been described in considerable detail with reference to certain preferred versions thereof, other versions are possible. Therefore the spirit and the scope of the claims should not be limited to the description of the preferred versions contained herein.

What is claimed is:

1. An interactive stroller for educating a child comprises:
a stroller, the stroller having at least three wheels a handle, a seat, and a pair of arms;
a tray, the tray attaches to the stroller; and
a player, the player attaches to the tray.

2. The interactive stroller of claim 1, further comprising a controller, the controller attaches to the stroller's handle, the controller connects to the player.

3. The interactive stroller of claim 2, wherein the tray has a front and a back, the tray defines a centrally located recess, the tray further defines at least two directly opposing inlets positioned adjacent to the front of the tray, the tray also defines a centrally located channel adjacent to the rear of the tray, and the tray lastly defines two holding means that attach to the arms of the stroller.

4. The interactive stroller of claim 3, wherein the player has a front and a back end, the back side of the player having two male holding devices, the male holding devices being directly opposed to each other and each male holding device being able to be in either an extended or a retracted position, the male holding devices being inserted within the inlets of the tray, the player further defines an opening centrally located in the front of the player.

5. The interactive stroller of claim 4, further comprising a locking means for locking the player within the recess of the tray, the locking means is housed within the channel of the tray.

6. The interactive stroller of claim 5, further comprising a charging device, the charging device attaches to the player.

7. The interactive stroller of claim 6, further comprising a pouch, the pouch attaches to the stroller, the pouch defines a means for storing CD's or other items.

8. The interactive stroller of claim 7, wherein the player is interactive and has a touch screen.

9. The interactive stroller of claim 8, wherein the controller controls the player.

10. The interactive stroller of claim 4, wherein the player is interactive and has a touch screen.

11. The interactive stroller of claim 10, wherein the controller controls the player.

12. The interactive stroller of claim 2, wherein the player is interactive and has a touch screen.

13. The interactive stroller of claim 3, wherein the controller controls the player.

14. An interactive stroller for educating a child comprises:
a stroller, the stroller having at least three wheels a handle, a seat, and a pair of arms;
a tray, the tray has a front and a back, the tray defines a centrally located recess, the tray further defines at least two directly opposing inlets positioned adjacent to the front of the tray, the tray also defines a centrally located channel adjacent to the rear of the tray, and the tray lastly defines two holding means that attach to the arms of the stroller;
a player, the player has a front and a back end, the back side of the player having two male holding devices, the male holding devices being directly opposed to each other and each male holding device being able to be in either an extended or a retracted position, the male holding devices being inserted within the inlets of the tray, the player further defines an opening centrally located in the front of the player, the player attaches to the tray; and
a controller, the controller attaches to the stroller's handle, the controller connects to the player.

15. The interactive stroller of claim 14, further comprising a locking means for locking the player within the recess of the tray, the locking means is housed within the channel of the tray.

16. The interactive stroller of claim 15, further comprising a charging device, the charging device attaches to the player.

17. The interactive stroller of claim 16, further comprising a pouch, the pouch attaches to the stroller, the pouch defines a means for storing CD's or other items.

18. The interactive stroller of claim 17, wherein the player is interactive and has a touch screen.

19. The interactive stroller of claim 18, wherein the controller controls the player.
